(19) United States
(12) Patent Application Publication
(10) Pub. No.: US 2025/0387881 A1
(43) Pub. Date: Dec. 25, 2025

(54) ANTI-SLIP SOCKET

(71) Applicant: RE-DAI PRECISION TOOLS CO.,LTD., TAICHUNG (TW)

(72) Inventors: HSIANG CHEN YU, TAICHUNG (TW); KUN YING HSIEH, TAICHUNG (TW)

(21) Appl. No.: 18/950,731

(22) Filed: Nov. 18, 2024

(30) Foreign Application Priority Data
Jun. 24, 2024 (TW) 113206629
Jul. 17, 2024 (TW) 113207684

(51) Int. Cl. B25B 13/06

(52) U.S. Cl. CPC B25B 13/065

(57) ABSTRACT

An anti-slip socket comprises a body and a plurality of anti-slip units. The body defines a driving end and a driven end. The body is provided with a driving hole being open at the driving end, and a diameter of the driving hole gradually decreases from the driving end toward the driven end. The driving hole is provided with a plurality of driving surfaces. The plurality of anti-slip units are respectively arranged on the plurality of driving surfaces. Therefore, the change in the diameter of the driving hole allows for the connection of fasteners of various sizes, and the anti-slip units effectively engage the fastener to provide an anti-slip effect.

### BACKGROUND OF THE INVENTION

The present invention relates to an anti-slip socket and, more particularly, to an anti-slip socket for fasteners of various sizes.

The general socket has a socket hole for fitting fasteners such as bolts, allowing the contact surface of the socket hole to engage with the edge of the fastener and thus turn the fastener. However, the inner diameter of the socket hole is typically slightly larger than the outer diameter of the fastener, causing the contact surface of the socket hole to only partially contact the edge of the fastener when the fastener is turned by the socket. This can easily lead to damage and deformation of the edge of the fastener, preventing the socket from effectively gripping and turning the fastener. Moreover, a general socket can only accommodate a single size of fastener, making it unable to meet the needs for assembling and disassembling fasteners of various sizes.

Thus, a need exists for an anti-slip socket to mitigate and/or obviate the above disadvantages.

### SUMMARY OF THE INVENTION

An objective of the present invention is to provide an anti-slip socket that includes a body and a plurality of anti-slip units. The body defines a driving end and a driven end, and the body is provided with a driving hole being open at the driving end. A diameter of the driving hole gradually decreases from the driving end toward the driven end, and the driving hole is provided with a plurality of driving surfaces. The plurality of anti-slip units are respectively arranged on the plurality of driving surfaces.

In an embodiment, the driving hole has a half cone angle of less than 70 degrees.

Further, the half cone angle is between 20 degrees and 30 degrees.

In another embodiment, the driving hole has a half cone angle greater than 30 degrees.

Further, the half cone angle is between 50 degrees and 60 degrees.

In an embodiment, each of the plurality of anti-slip units includes a plurality of engaging grooves.

In an embodiment, the driving hole extends along a driving axis passing through the driving end and the driven end. Each of the plurality of engaging grooves of each anti-slip unit extends obliquely around the driving axis and is arranged sequentially along a longitudinal direction of the driving axis.

In an embodiment, the plurality of engaging grooves of the plurality of anti-slip units collectively form an internal thread structure.

Further, the internal thread structure is a sawtooth thread.

In an embodiment, each of the plurality of engaging grooves of each anti-slip unit has an equal groove depth.

In an embodiment, the body is further provided with a driven hole, and the driven hole is open at the driven end.

In an embodiment, the driving hole is provided with a plurality of spacing slots, and each of the plurality of spacing slots is located between two adjacent driving surfaces.

Further, each of the plurality of spacing slots extends from the driving end toward the driven end.

In an embodiment, each of the plurality of spacing slots communicates with each of the plurality of engaging grooves of each anti-slip unit.

In an embodiment, the number of the plurality of spacing slots is six, and the six spacing slots are spaced 60 degrees apart in a circumferential direction of the driving axis.

In another embodiment, the number of the plurality of spacing slots is three, and the three spacing slots are spaced 120 degrees apart in the circumferential direction of the driving axis.

The present invention will become clearer in light of the following detailed description of illustrative embodiments of this invention described in connection with the drawings.

### BRIEF DESCRIPTION OF DRAWINGS

FIG. 1 is a perspective view of an anti-slip socket of a first embodiment according to the present invention.

FIG. 2 is a cross sectional view of the anti-slip socket of FIG. 1.

FIG. 3 is another cross sectional view of the anti-slip socket of FIG. 1.

FIG. 4 is a side view of the anti-slip socket of FIG. 1.

FIG. 5 is a perspective view of an anti-slip socket of a second embodiment according to the present invention.

FIG. 6 is a cross sectional view of the anti-slip socket of FIG. 5.

FIG. 7 is a side view of the anti-slip socket of FIG. 5.

FIG. 8 is a perspective view of an anti-slip socket of a third embodiment according to the present invention.

FIG. 9 is a cross sectional view of the anti-slip socket of FIG. 8.

FIG. 10 is a side view of the anti-slip socket of FIG. 8.

### DETAILED DESCRIPTION OF THE INVENTION

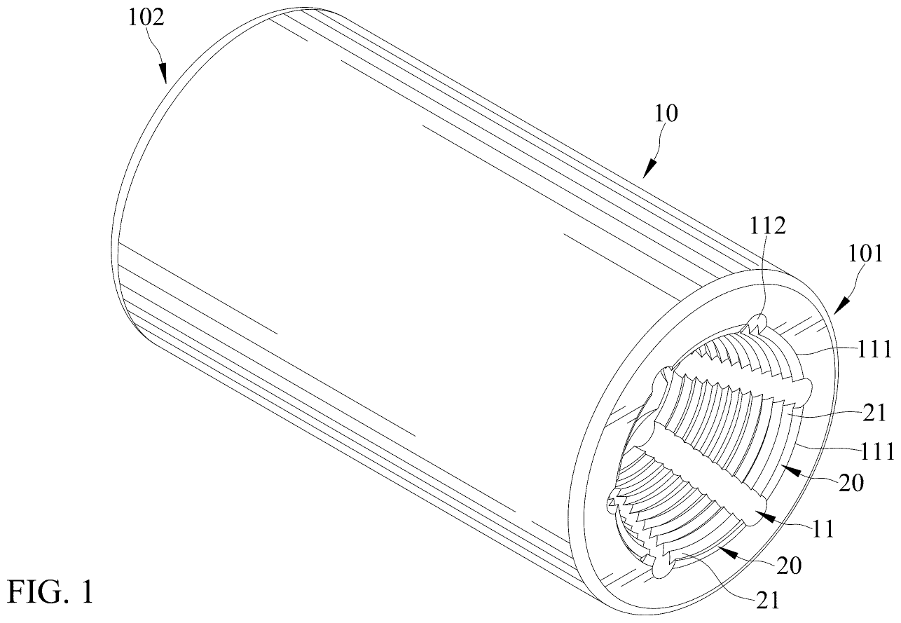

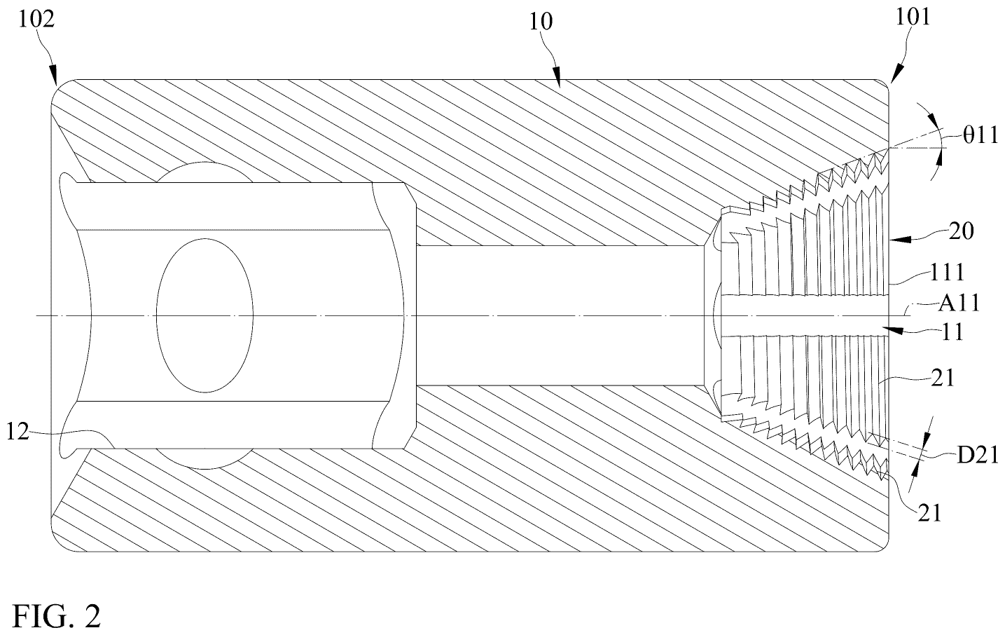

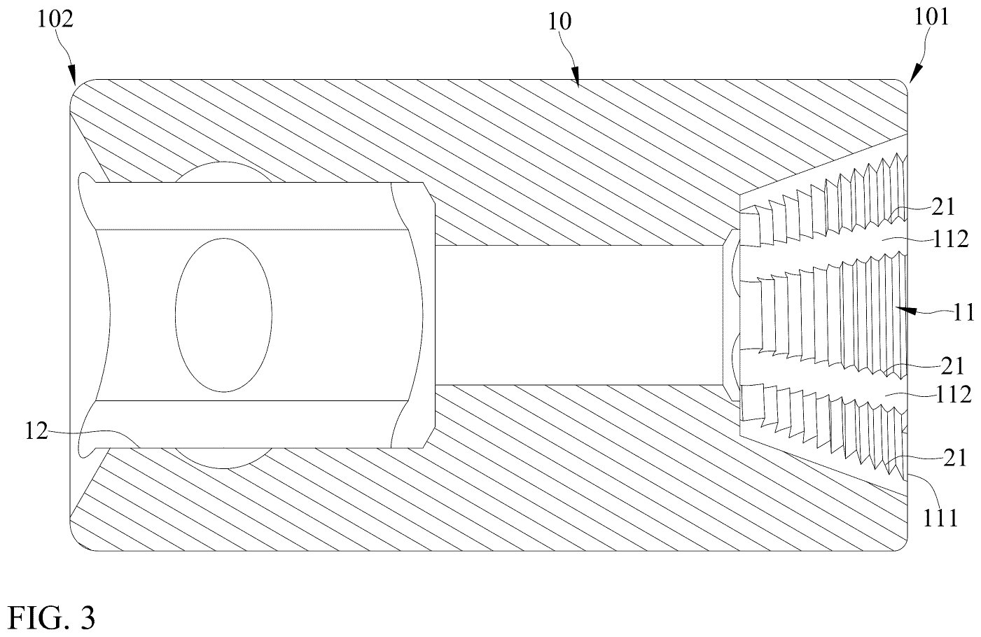

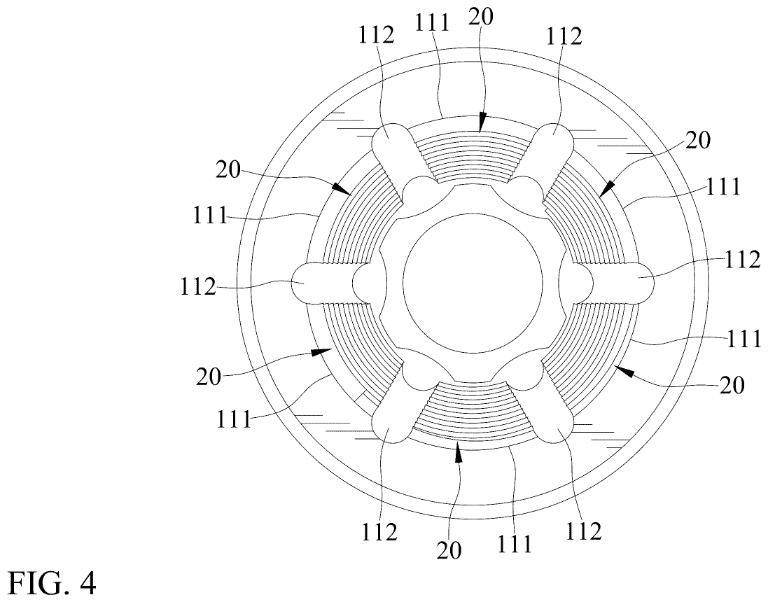

FIGS. 1-4 show an anti-slip socket of a first embodiment according to the present invention. The anti-slip socket comprises a body 10 and a plurality of anti-slip units 20. The body 10 defines a driving end 101 and a driven end 102, and the body 10 is provided with a driving hole 11 extending along a driving axis A11 passing through the driving end 101 and the driven end 102 and being open at the driving end 101 to receive fasteners such as bolts and nuts (not shown). A diameter of the driving hole 11 gradually decreases from the driving end 101 toward the driven end 102, forming a tapered hole. The driving hole 11 is provided with a plurality of driving surfaces 111 for contacting fasteners. The driving surfaces 111 may be flat or curved. The body 10 is further provided with a driven hole 12, which is open at the driven end 102 for being driven by a driving tool.

Additionally, the driving hole 11 may be provided with a plurality of spacing slots 112. Each of the plurality of spacing slots 112 is located between two adjacent driving surfaces 111, extends from the driving end 101 toward the driven end 102, and communicates with each of the plurality of engaging grooves 21. In the embodiment, the number of the plurality of spacing slots 112 is six, and the six spacing slots 112 are spaced 60 degrees apart in a circumferential direction of the driving axis A11. Therefore, it can be understood that the drive hole 11 may be configured as a hexagonal, octagonal, dodecagonal, or other polygonal hole as needed.

The plurality of anti-slip units 20 are respectively arranged on the plurality of driving surfaces 111 to enhance the engaging effect between the drive hole 11 and the fastener, achieving an anti-slip effect.

Furthermore, the driving hole 11 may have a half cone angle θ11 of less than 70 degrees. More preferably, in the embodiment, the half cone angle θ11 may be between 20 degrees and 30 degrees.

To ensure that the anti-slip units 20 provide the effective engaging effect with the fastener, each of the plurality of anti-slip units 20 includes a plurality of engaging grooves 21. Each of the plurality of engaging grooves 21 extends obliquely around the driving axis A11 and is arranged sequentially along a longitudinal direction of the driving axis A11, collectively forming an internal thread structure, which may be in the form of a sawtooth thread.

In the embodiment, each of the plurality of engaging grooves 21 has an equal groove depth D21. Specifically, the groove depth D21 refers to a distance that the engaging groove 21 is recessed into the driving surface 111. It can be understood that the groove depth D21 may be adjusted as needed.

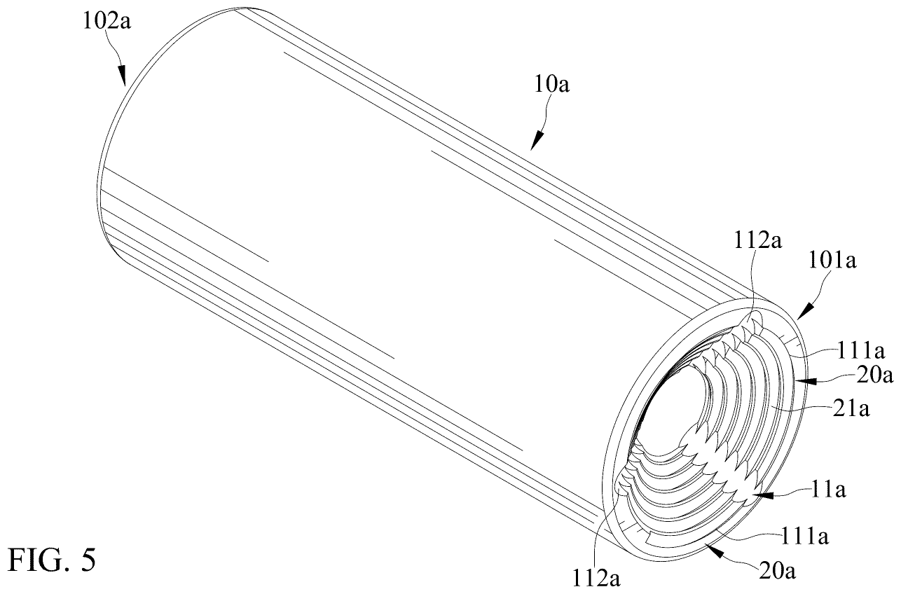

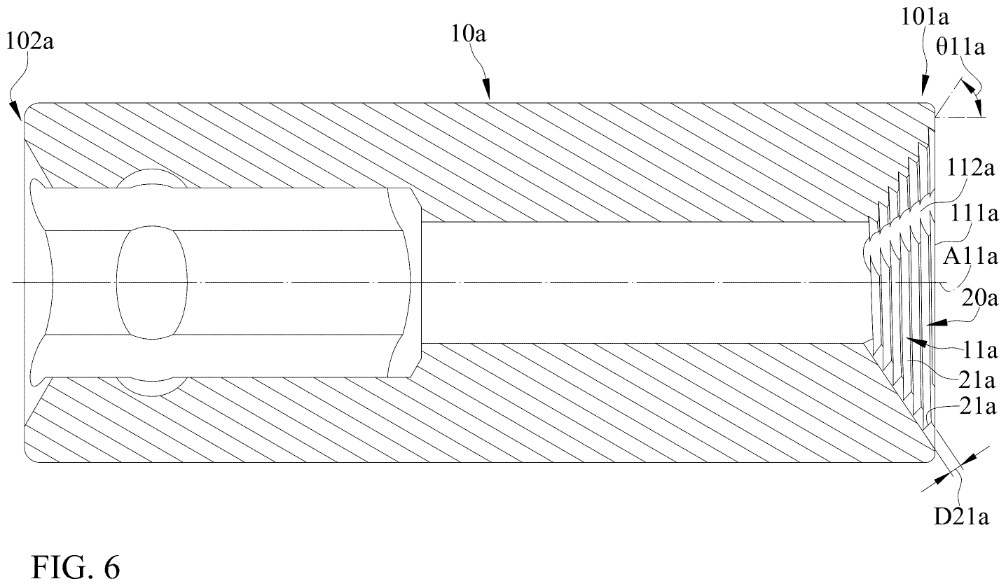

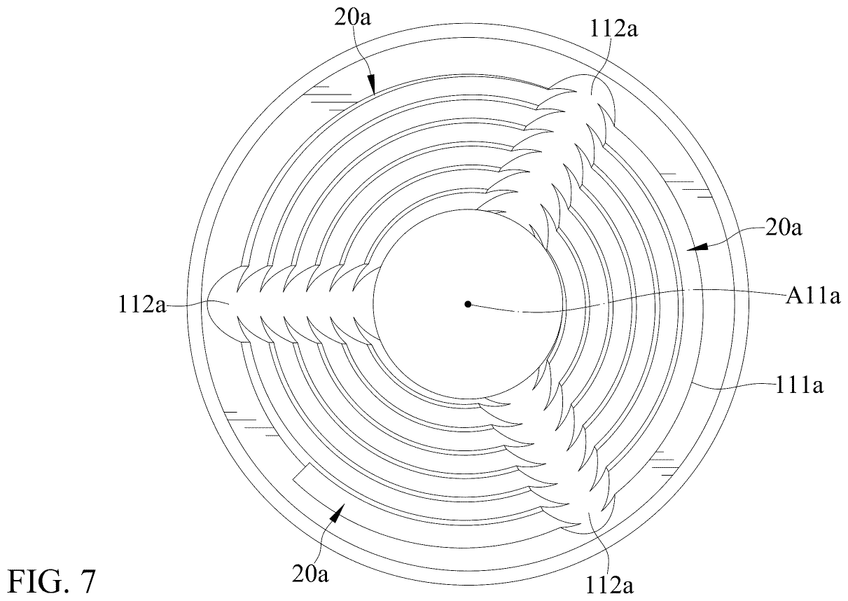

FIGS. 5-7 show an anti-slip socket of a second embodiment according to the present invention. The anti-slip socket comprises a body 10a and a plurality of anti-slip units 20a. The body 10a defines a driving end 101a and a driven end 102a, and the body 10a is provided with a driving hole 11a extending along a driving axis A11a passing through the driving end 101a and the driven end 102a and being open at the driving end 101a to receive fasteners such as bolts and nuts (not shown). A diameter of the driving hole 11a gradually decreases from the driving end 101a toward the driven end 102a, forming a tapered hole. The driving hole 11a is provided with a plurality of driving surfaces 111a for contacting fasteners. The driving surfaces 111a may be flat or curved. The body 10a is further provided with a driven hole 12a, which is open at the driven end 102a for being driven by a driving tool.

Additionally, the driving hole 11a may be provided with a plurality of spacing slots 112a. Each of the plurality of spacing slots 112a is located between two adjacent driving surfaces 111a, extends from the driving end 101a toward the driven end 102a, and communicates with each of the plurality of engaging grooves 21a. In the embodiment, the number of the plurality of spacing slots 112a is three, and the three spacing slots 112a are spaced 120 degrees apart in a circumferential direction of the driving axis A11a. Therefore, it can be understood that the drive hole 11a may be configured as a hexagonal, octagonal, dodecagonal, or other polygonal hole as needed.

The plurality of anti-slip units 20a are respectively arranged on the plurality of driving surfaces 111a to enhance the engaging effect between the drive hole 11a and the fastener, achieving an anti-slip effect.

Furthermore, the driving hole 11a may have a half cone angle θ11a of greater than 30 degrees. More preferably, in the embodiment, the half cone angle θ11a is between 50 degrees and 60 degrees.

To ensure that the anti-slip units 20a provide the effective engaging effect with the fastener, each of the plurality of anti-slip units 20a includes a plurality of engaging grooves 21a. Each of the plurality of engaging grooves 21a extends obliquely around the driving axis A11a and is arranged sequentially along a longitudinal direction of the driving axis A11a, collectively forming an internal thread structure, which may be in the form of a sawtooth thread.

In the embodiment, each of the plurality of engaging grooves 21a has an equal groove depth D21a. Specifically, the groove depth D21a refers to a distance that the engaging groove 21a is recessed into the driving surface 111a. It can be understood that the groove depth D21 may be adjusted as needed.

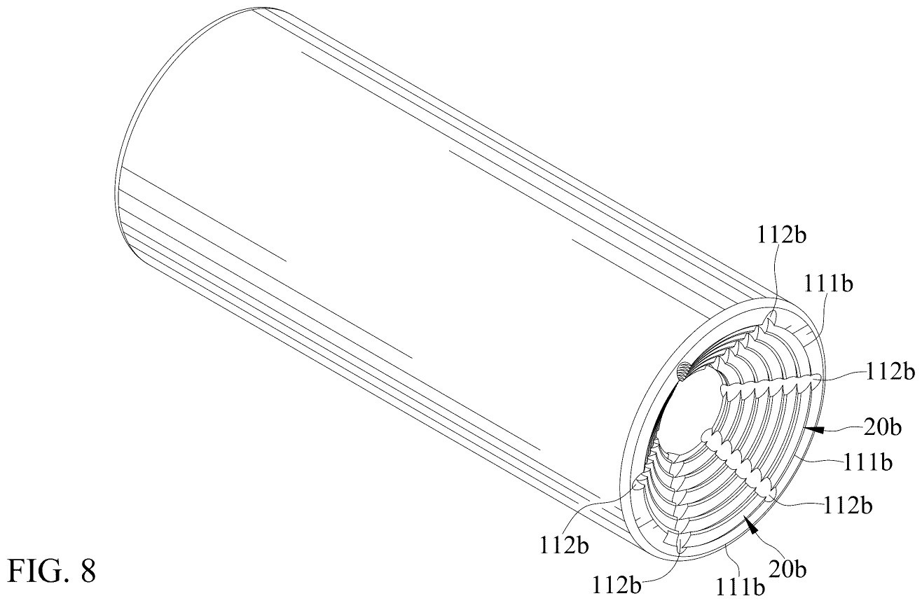

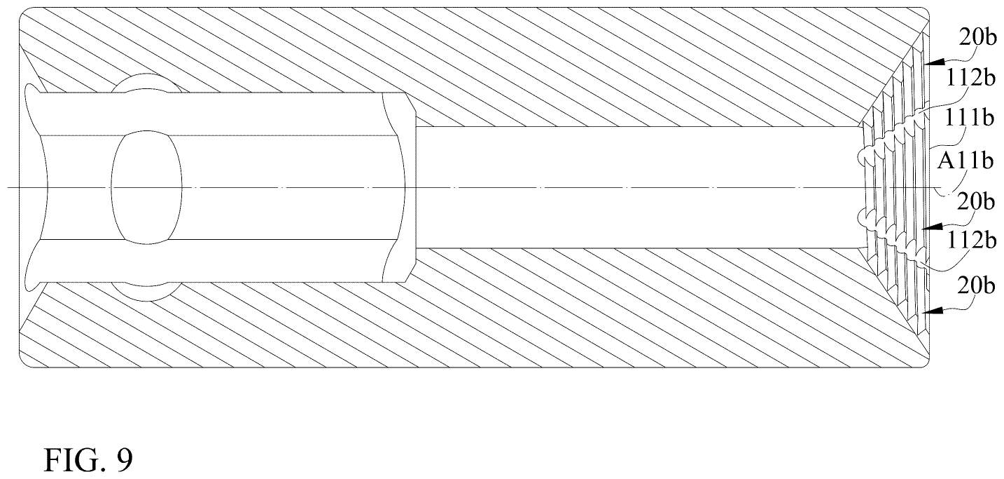

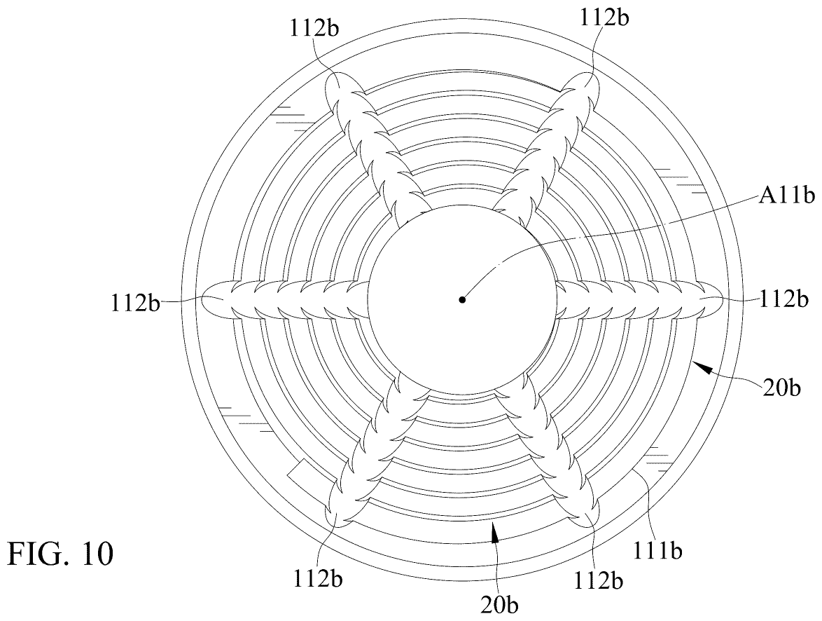

FIGS. 8-10 show an anti-slip socket of a third embodiment according to the present invention. The third embodiment is substantially the same as the second embodiment, and the main difference therebetween is that the number of the plurality of spacing slots 112b is three, and the three spacing slots 112b are spaced 120 degrees apart in the circumferential direction of the driving axis A11b.

In summary, in the anti-slip socket provided by the embodiments of the present invention, the variation in the diameter of the driving holes 11 and 11a allows for the connection of fasteners of various sizes. Specifically, the larger the half cone angles θ11 and θ11a, the more sizes of fasteners can be driven. Furthermore, larger fasteners can be accommodated by the portion of the driving holes 11 and 11a near the driving ends 101 and 101a, while smaller fasteners can be accommodated by the portion of the driving holes 11 and 11a farther from the driving ends 101 and 101a. This enables fasteners of different sizes to come into contact with the anti-slip units 20, 20a, and 20b. The engaging grooves 21, 21a of the anti-slip units 20, 20a, and 20b engage with the outer edges of the fasteners, enhancing the anti-slip effect and allowing the fasteners to be effectively turned.

Although specific embodiments have been illustrated and described, numerous modifications and variations are still possible without departing from the scope of the invention. The scope of the invention is limited by the accompanying claims.

1. An anti-slip socket comprising:
a body defining a driving end and a driven end, wherein the body is provided with a driving hole being open at the driving end, wherein a diameter of the driving hole gradually decreases from the driving end toward the driven end, and wherein the driving hole is provided with a plurality of driving surfaces; and
a plurality of anti-slip units respectively arranged on the plurality of driving surfaces.

2. The anti-slip socket as claimed in claim 1, wherein the driving hole has a half cone angle of less than 70 degrees.

3. The anti-slip socket as claimed in claim 2, wherein the half cone angle is between 20 degrees and 30 degrees.

4. The anti-slip socket as claimed in claim 1, wherein the driving hole has a half cone angle greater than 30 degrees.

5. The anti-slip socket as claimed in claim 4, wherein the half cone angle is between 50 degrees and 60 degrees.

6. The anti-slip socket as claimed in claim 1, wherein each of the plurality of anti-slip units includes a plurality of engaging grooves.

7. The anti-slip socket as claimed in claim 6, wherein the driving hole extends along a driving axis passing through the driving end and the driven end, and wherein each of the plurality of engaging grooves of each anti-slip unit extends obliquely around the driving axis and is arranged sequentially along a longitudinal direction of the driving axis.

8. The anti-slip socket as claimed in claim 7, wherein the plurality of engaging grooves of the plurality of anti-slip units collectively form an internal thread structure.

9. The anti-slip socket as claimed in claim 8, wherein the internal thread structure is a sawtooth thread.

10. The anti-slip socket as claimed in claim 6, wherein each of the plurality of engaging grooves of each anti-slip unit has an equal groove depth.

11. The anti-slip socket as claimed in claim 1, wherein the body is further provided with a driven hole, and wherein the driven hole is open at the driven end.

12. The anti-slip socket as claimed in claim 7, wherein the driving hole is provided with a plurality of spacing slots, and wherein each of the plurality of spacing slots is located between two adjacent driving surfaces.

13. The anti-slip socket as claimed in claim 12, wherein each of the plurality of spacing slots extends from the driving end toward the driven end.

14. The anti-slip socket as claimed in claim 13, wherein each of the plurality of spacing slots communicates with each of the plurality of engaging grooves of each anti-slip unit.

15. The anti-slip socket as claimed in claim 12, wherein the number of the plurality of spacing slots is six, and wherein the six spacing slots are spaced 60 degrees apart in a circumferential direction of the driving axis.

16. The anti-slip socket as claimed in claim 12, wherein the number of the plurality of spacing slots is three, and wherein the three spacing slots are spaced 120 degrees apart in the circumferential direction of the driving axis.
